(19) United States
(12) Patent Application Publication
(10) Pub. No.: US 2025/0073615 A1
(43) Pub. Date: Mar. 6, 2025

(54) SYSTEMS AND METHODS FOR ENHANCING DEGASSING TANK OIL AND WATER SEPARATION USING MICROWAVE ELECTROMAGNETIC ENERGY

(71) Applicant: SAUDI ARABIAN OIL COMPANY, Dhahran (SA)

(72) Inventors: Hatim Awad ALSHAMMARI, Dhahran (SA); Abdullah S. ALHUSSAIN, Tanajib (SA)

(73) Assignee: SAUDI ARABIAN OIL COMPANY, Dhahran (SA)

(21) Appl. No.: 18/460,359

(22) Filed: Sep. 1, 2023

(51) Int. Cl. B01D 17/06; B01D 19/00; C10G 33/02

(52) U.S. Cl. CPC B01D 17/06; B01D 19/0068; C10G 33/02

(57) ABSTRACT

A separation system uses electromagnetic energy to facilitate separation of water and oil from crude oil. The separation system includes a degassing tank, a microwave cavity arranged inside the degassing tank, and a microwave generating system for generating and transmitting electromagnetic energy to the microwave cavity. Crude oil is introduced into the microwave cavity, where the crude oil is exposed to electromagnetic energy, in order to separate water and oil from the crude oil, and the electromagnetic energy interacts with a crude oil introduced into the interior volume to enhance separation of oil from water in the crude oil.

### FIELD OF THE DISCLOSURE

The present disclosure relates generally to hydrocarbon product and, more particularly, to the separation of oil and water dispersions and emulsions in degassing tanks.

### BACKGROUND OF THE DISCLOSURE

When extracting hydrocarbons from underground reservoirs, the extracted product is rarely pure crude oil and instead often comprises an emulsified mixture of oils, waxes, tars, salt and mineral laden water, fine sands and mineral particulates, etc. Some natural settling and stratification occurs to this product when storing at the well and refinery sites, but an emulsion of oil and water typically remains nevertheless, and it is desirable to remove the oil from such water for economic and environmental reasons.

However, separating the water from the oil can be challenging, and there are many process steps and methods to achieve this result. One of these methods includes utilization of a degassing tank, which is a 3-phase separator that separates the emulsion into component parts of gas, water, and oil. The separated gas is discharged from the degassing tank via a gas outlet, while the separated water and oil streams are discharged through separate water and oil outlet streams.

The efficiency of the separation process to separate the oil from the water varies depending in different factors, such as the grade of the crude oil, the American Petroleum Institute (“API”) gravity of the crude oil, process parameters, residence time, and chemical aid injection that will enhance the separation by breaking the emulsion of oil-in-water. Improved separation processes are desired to enhance the efficiency of gas/oil separation, especially in the oil and gas industry and gas-oil separation plants.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a separation system is disclosed. The separation system includes a degassing tank defining an interior volume, a microwave cavity provided within the interior volume, and a microwave generating system. The microwave generating system is operable for transmitting electromagnetic energy in the form of microwaves to the microwave cavity, and the microwave generating system includes a microwave generator operable to generate the electromagnetic energy, wherein the electromagnetic energy interacts with crude oil introduced into the interior volume and enhances separation of oil from water in the crude oil. In embodiments, the degassing tank comprises a three-phase separator. In embodiments, the microwave cavity is disposed on an internal surface of a sidewall of the degassing tank, and the internal surface of the sidewall of the degassing tank defines the interior volume. In further embodiments, the microwave generator is disposed on a top side of the degassing tank and/or the mode stirrer distributes the microwaves in all directions within the microwave cavity. In embodiments, the microwave generator includes a magnetron and a power supply that powers the magnetron, and wherein the magnetron and the power supply are disposed on a top side of the degassing tank. In embodiments, the microwave generating system further includes a waveguide operatively coupled to the microwave generator for guiding the electromagnetic energy into the microwave cavity. In further embodiments, the waveguide is disposed on a top side of the degassing tank. In further embodiments, the microwave generating system further includes a mode stirrer operatively coupled to the waveguide and operable to distribute the electromagnetic energy into the microwave cavity and, in even further embodiments, the mode stirrer is disposed within the degassing tank. In embodiments, the microwave generator further comprises a magnetron and a power supply that powers the magnetron, and the microwave generating system further includes a waveguide operatively coupled to the magnetron for guiding the electromagnetic energy into the microwave cavity, and a mode stirrer operatively coupled to the waveguide and operable to distribute the electromagnetic energy received from the waveguide within the microwave cavity. In further embodiments, the microwave generator, the power supply, and the waveguide are all disposed on a top side of the degassing tank, and the mode stirrer is arranged within the interior volume.

In another embodiment, a method of separating oil and water from crude oil is disclosed. The method may include inputting the crude oil into a microwave cavity provided within an interior volume of a degassing tank, and transmitting electromagnetic energy to the microwave cavity via a microwave generating system. The microwave generating system may include a microwave generator operable to generate the electromagnetic energy in the form of microwaves, wherein the electromagnetic energy interacts with the crude oil introduced into the interior volume and enhances separation of the oil from the water in the crude oil. In a further embodiment, the method includes discharging the oil from the degassing tank via a first output and discharging the water from the degassing tank via a second output. In yet another embodiment, the method further includes separating a gas from the crude oil and discharging the gas from the degassing tank via a third output.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 schematically depicts a system for separating oil and water, according to one or more embodiments of the present disclosure.

FIG. 2 depicts an example method of operating the system of FIG. 1, according to one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to hydrocarbon production and, more specifically, to the separation of oil and water dispersions and emulsions. Described herein are separation systems that use electromagnetic energy to enhance separation of water and oil from crude oil. The separation system may include a degassing tank in which a microwave cavity is defined and into which the crude oil is introduced. In addition, the separation system may include a microwave generating system for transmitting electromagnetic energy to or into the microwave cavity. The microwave generating system may include a microwave generator operatively coupled to or adjacent the microwave cavity. In some embodiments, the microwave generating system also includes a waveguide and a mode stirrer, wherein the waveguide transmits/directs/guides the electromagnetic energy from the microwave generator to the mode stirrer and the mode stirrer distributes the electromagnetic energy received from the waveguide within the microwave cavity. In some embodiments, the microwave generator includes a magnetron and a power supply, which supplies power to the magnetron. The magnetron generates the electromagnetic energy and directs such electromagnetic energy to the waveguide. In some embodiments, one or more components of microwave generating system are provided on an upper surface of the degassing tank.

Once the microwave radiation infiltrates the crude oil, the total energy is absorbed depending on the dielectric properties of the emulsion, which causes an increase in the temperature of the material. This will achieve an emulsion breakage without increasing the chemical dosage and, as a result, the water will be more easily separated from the oil. Using optimum chemical dosage and a predetermined residence time within the degassing tank, when combined with the microwave energy system, the separation of oil and water can be improved and this may lead to enhanced separation of oil and water and emulsion breakage. The principles described herein can potentially save on costs and energy by minimizing the need for further (downstream) separation processes.

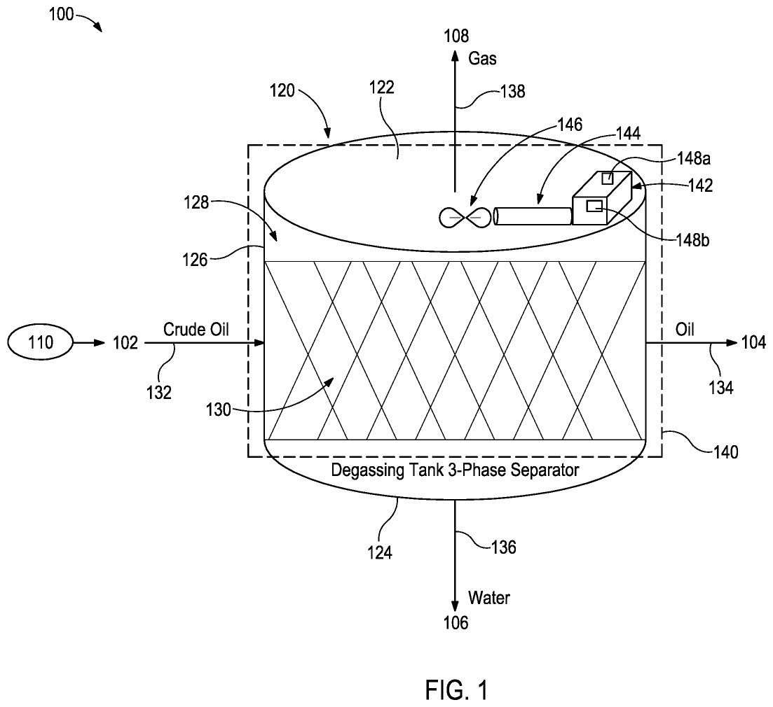

FIG. 1 schematically depicts an example separation system 100, according to one or more embodiments of the present disclosure. The separation system 100 (hereinafter, “the system 100”) can be used to break down crude oil 102 and separate the crude oil 102 into separate streams of oil 104 and water 106. In embodiments, the system 100 also breaks down and separates the crude oil 102 into a stream of gas 108. The crude oil 102 may be supplied by a low-pressure production trap (“LPPT”) separator 110, which may be a two-way separator. The LPPT separator comprises a 2-phase separator operable to separate oil and gas.

In the illustrated embodiment, the system 110 includes a degassing tank 120, which may comprise a three-phase separator. In some embodiments, the LPPT 110 and the degassing tank 120 may form part of a gas-oil separation plant (GOSP) used in the oil and gas industry. The degassing tank 120 may be operable to receive the crude oil 102 from the LPPT 110, separate oil from water in the emulsion 102, and discharge corresponding streams of oil 104, water 106, and gas 108.

As illustrated, the degassing tank 120 includes a first or “upper” side 122, a second or “lower” side 124 opposite the upper side 122, and a sidewall 126 extends between the upper and lower sides 122, 124. The degassing tank 120 also provides an interior volume 128 generally defined by the upper and lower sides 122, 124 and the sidewall 126. A microwave cavity 130 may be defined or otherwise provided within the interior volume 128 of the degassing tank 120. In some embodiments, the microwave cavity 130 is disposed on the interior surfaces of the sidewalls 126 (and/or an internal sidewall of the degassing tank 120). The microwave cavity 130 operates as a type of resonator that comprises a close metal structure that confines electromagnetic fields in an enclosed region. The microwave cavity 130 works by constructive or destructive interference of waves. The microwave cavity 130 may be infused with the internal wall of the degassing tank 120 or may comprise a separate component part that can be welded to internal surfaces of the degassing tank 120.

The system 100 includes an input 132 through which the crude oil 102 may be introduced into the degassing tank 120 and, more specifically, into the microwave cavity 130. The input 132 may include a pipeline or conduit. The system 100 also includes various outputs (e.g., output pipelines or conduits) through which the various broken down (separated) components of the crude oil 102 may be discharged from the degassing tank 120. For example, the degassing tank 120 includes a first output 134 through which the separated oil 104 exits, and a second output 136 through which the separated water 106 exits. In addition, the degassing tank 120 may include a third output 138 through which the separated gas 108 exits the degassing tank 120.

As shown, the second output 136 is arranged at or near the lower side 124 of the degassing tank 120, such that the water 106 settling in the degassing tank 120 may accumulate proximate to the second output 136 via gravity and drain out through the second output 136 with the help of gravity. Also, the third output 138 is arranged at or near the upper side 122 of the degassing tank 120 such that the gas 108 separating form the other contents within the degassing tank 120 may accumulate proximate the upper side 122 of the degassing tank 120 and vent out and escape through the third output 138. In embodiments, the first output 134 is a first pipe, the second output 136 is a second pipe, and the third output 138 is a third pipe. The degassing tank 120 is operated at atmospheric pressure and the gas 108 is vented through the third output 138, while the water 106 may be pumped to a downstream water treatment system using a draw-off pump, for example. The draw-off pump may be controlled by a level transmitter operable to measure the fluid level of the water 106 within the degassing tank 120.

According to embodiments of the present disclosure, the system 100 may further include a microwave generating system 140 operable for generating and transmitting electromagnetic energy to the microwave cavity 130 to help enhance the separation of the oil 104 and the water 106 within the degassing tank 120. As shown, the microwave generating system 140 can include a microwave generator 142, a waveguide 144, and a mode stirrer 146.

The microwave generator 142 may be configured to generate electromagnetic energy in the form of microwaves, and the waveguide 144 may be operatively coupled to the microwave generator 142 for guiding the electromagnetic energy to the microwave cavity 130 to interact with the incoming crude oil 102. The mode stirrer 146 may be operatively coupled to the waveguide 144 and the microwave cavity 130 for distributing the electromagnetic energy (microwaves) received from the waveguide 144 within the microwave cavity 130.

In the illustrated embodiment, the microwave generator 142 includes a magnetron 148a and a power supply 148b that supplies power to the magnetron 148a. The waveguide 144 is operatively coupled to the magnetron 148a for guiding electromagnetic energy generated by the microwave generator 142. In some embodiments, the waveguide 144 may comprise a dielectric waveguide constructed of a metal that acts as an insulator and provides a pathway for the microwaves to travel. Moreover, the mode stirrer 146 is operatively coupled to the waveguide 144 and the microwave cavity 130 for distributing electromagnetic energy received from the waveguide 144 within the microwave cavity 130.

The microwaves or microwave energy is generated by the magnetron 148a is passed through a tube to the waveguide 144, which guides and transfers the microwaves to the mode stirrer 146. In some embodiments, the waveguide 144 penetrates the upper side 122 of the degassing tank 120 to convey the microwave energy to the mode stirrer 146, which may be secured within the interior of the degassing tank 120. In at least one embodiment, the mode stirrer 146 may be mounted or arranged within a box or box-shaped structure and may include a motor used to operate the mode stirrer 146. In such embodiments the waveguide 144 also penetrates the box to deliver the microwave energy to the mode stirrer 146. The box may have a plurality of openings in all directions and sides to enable the distribution of the microwave energy in all directions. The mode stirrer 146 may be configured to emit microwave energy uniformly within the microwave cavity 130.

The microwave generator 142, the waveguide 144, and the mode stirrer 146 may be provided and otherwise secured at various locations relative to the degassing tank 120. In the illustrated embodiment, the microwave generator 142 (including both magnetron 148a and the power supply 148b), the waveguide 144, and the mode stirrer 146 are all provided on the upper side 122 of the degassing tank 120. In other embodiments, however, one or more of the microwave generator 142, the waveguide 144, and the mode stirrer 146 may be provided elsewhere on the degassing tank 120, or even on another structure/support that is not a part of the degassing tank 120. In at least one embodiment, for example, one or more of the microwave generator 142, the waveguide 144, and the mode stirrer 146 may be provided on an external support structure (not illustrated).

By including the microwave generating system 140, the system 100 provides an efficient means of separating the oil 104 and the water 106 (and the gas 108) from the crude oil 102. In example operation, the crude oil 102 enters the degassing tank 120 via the input 132 and is introduced into the microwave cavity 130. The microwave generator 142 may then be operated to generate electromagnetic energy in the form of microwaves. The electromagnetic energy is directed toward or inside the microwave cavity 130 to radiate through the crude oil 102. The propagating microwaves increase the temperature of the emulsion 102, while simultaneously rearranging the electrical charge distribution of the water molecules by rotating the water molecule dipoles and allowing ions to move around the resulting drops of water 106. More specifically, this results in a rearrangement of the molecules of the water 106 and encourages the merger of the molecules of the water 106 with other water molecules as they get heavier and increase in size. When dipolar molecules are subjected to an electric field, such as microwaves, they respond by rotating, which allows their positive and negative molecules to line up with the field then rotating back and forth.

Once the microwave radiation infiltrates the crude oil 102, the total energy is absorbed in the water 106 depending on the dielectric properties of the emulsion of the crude oil 102, which cause an increase in the temperature of the crude oil 102. Increased temperature of the crude oil 102 aids in the breakdown of the oil-water emulsion of the crude oil 102 and enhances separation of the water 106 from the oil 104. This will achieve an emulsion breakage without increasing the chemical dosage and as a result the water 106 will be separated from the oil 104. This ultimately enhances the separation (i.e., increases the rate of separation) as larger amounts of molecules of the water 106 will escape the degassing tank 120 via the second output 136.

With the help of the microwave generating system 140, the system 100 will achieve more efficient breakage of the oil-water emulsion of the crude oil 102 without using or injecting additional chemicals to the crude oil 102 and, as a result, the water 106 will be separated from the oil 104. Common chemicals used to help break the oil-water emulsion include demulsifiers, which are typically introduced (injected) before the LPPT separator 110. Using optimum chemical dosage and utilizing the residence time of degassing tank 120 when combined with the microwave generating system 140, the separation of the oil 104 and the water 106 can be improved and this could lead to enhancement of separation of the oil 104 and the water 106 and emulsion breakage (i.e., break-down of the crude oil 102). The gas 108 is seprated due to a drop in pressure within the degassing tank 120. The pressure of the crude oil 102 before the degassing tank 120 is around 50 psig, and is introduced into the degassing tank 120 at atomsperic pressure, which results in the gas 108 separating from the oil 104 and the water 106 since it has a different density than the liquid phase (oil+water).

In sum, the system 100 will provide cost and energy savings by minimizing the implementation of further separation processes. For example, utilization of the system 100 may inhibit the need of installing heat exchangers upstream from the degassing tank 120, as the utilization of electromagnetic energy provides a better means of increasing temperature than such heat exchangers and reduces energy consumption.

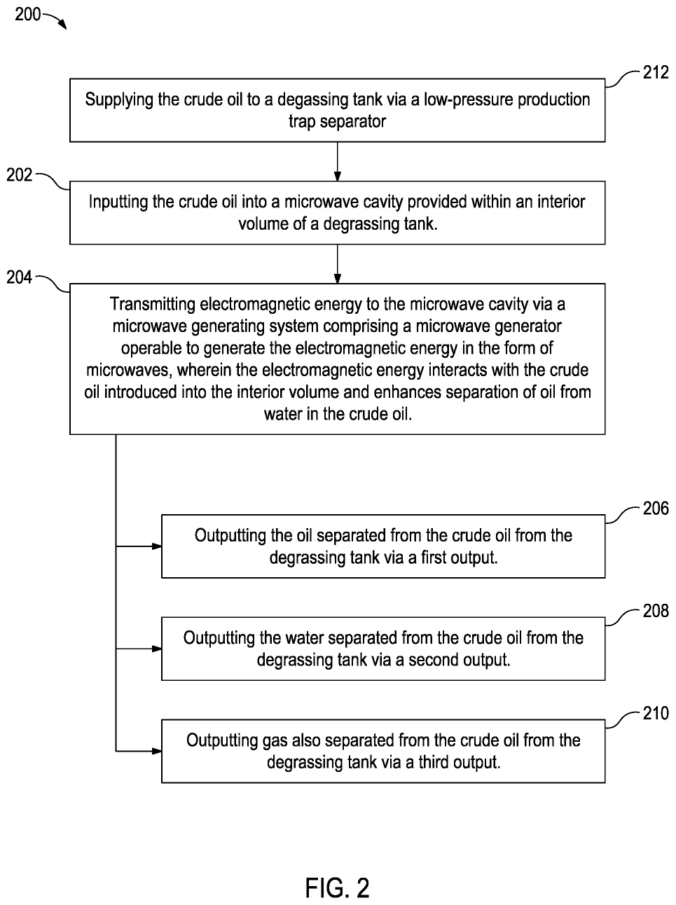

Referring now to FIG. 2, with continued reference to FIG. 1, depicted is a schematic diagram of an example method 200 of operating the system 100, according to one or more embodiments. In the illustrated embodiment, the method 200 includes inputting the crude oil 102 into the microwave cavity 130 provided within the interior volume 128 of the degassing tank 120, as at 202. The method 200 also includes transmitting (conveying) electromagnetic energy to the microwave cavity 130 via the microwave generating system 140, as at 204. As described above, the microwave generating system 140 includes the microwave generator 142 operable to generate the electromagnetic energy in the form of microwaves, and the electromagnetic energy is able to interact with the crude oil 102 to enhance separation of the oil 104 from the water 106.

In some embodiments, the second step 204 may further include generating the

electromagnetic energy via the microwave generator 142 and directing the electromagnetic energy to the mode stirrer 146 via the waveguide 144. In embodiments, the second step 204 may further include distributing the electromagnetic energy within the microwave cavity 130 via the mode stirrer 146 and, in such embodiments, the mode stirrer 146 may be operatively coupled to the waveguide 144 and the microwave cavity 130 for distributing the electromagnetic energy received from the waveguide 144 within the microwave cavity 130. In embodiments, the second step 204 may further include transmitting the electromagnetic energy from the upper side 122 of the degassing tank 120 to the microwave cavity 130.

The method 200 may further include discharging the oil 104 from the degassing tank 120 via the first output 134, as at 206, discharging the water 106 from the degassing tank 120 via the second output 136, as at 208, and discharging the gas 108 from the degassing tank 120 via the third output 138, as at 210. As will be appreciated, steps 206, 208, and 210 may occur simultaneously.

In some embodiments, as mentioned above, the crude oil 102 is introduced to the degassing tank 120 via the input 132 and, in some of these embodiments, the crude oil 102 is supplied to the input 132 and then the degassing tank 120 via the LPPT 110 (i.e., a two-way separator). Accordingly, in some embodiments, the method 200 may also include supplying the crude oil 102 to the input 132 and then the degassing tank 120 via the LPPT 110, as at 212, which precedes 202.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

The use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A separation system, comprising:
a degassing tank defining an interior volume;
a microwave cavity provided within the interior volume; and
a microwave generating system for transmitting electromagnetic energy in the form of microwaves to the microwave cavity, the microwave generating system including a microwave generator operable to generate the electromagnetic energy,
wherein the electromagnetic energy interacts with crude oil introduced into the interior volume and enhances separation of oil from water in the crude oil.

2. The separation system of claim 1, wherein the degassing tank comprises a three-phase separator.
The separation system of claim 1, wherein the microwave cavity is disposed on an internal surface of a sidewall of the degassing tank, and the internal surface of the sidewall of the degassing tank defines the interior volume.

3. The separation system of claim 1, wherein the microwave generator system further includes a mode stirrer arranged within the degassing thank and a waveguide that penetrates the degassing tank to guide the microwaves to the mode stirrer.

4. The separation system of claim 3, wherein the microwave generator is disposed on a top side of the degassing tank.

5. The separation system of claim 3, wherein the mode stirrer distributes the microwaves in all directions within the microwave cavity.

6. The separation system of claim 1, wherein the microwave generator includes a magnetron and a power supply that powers the magnetron, and wherein the magnetron and the power supply are disposed on a top side of the degassing tank.

7. The separation system of claim 1, wherein the microwave generating system further includes a waveguide operatively coupled to the microwave generator for guiding the electromagnetic energy into the microwave cavity.

8. The separation system of claim 7, wherein the waveguide is disposed on a top side of the degassing tank.

9. The separation system of claim 7, wherein the microwave generating system further includes a mode stirrer operatively coupled to the waveguide and operable to distribute the electromagnetic energy into the microwave cavity.

10. The separation system of claim 9, wherein the mode stirrer is disposed within the degassing tank.

11. The separation system of claim 1, wherein the microwave generator further comprises a magnetron and a power supply that powers the magnetron, and the microwave generating system further includes:
a waveguide operatively coupled to the magnetron for guiding the electromagnetic energy into the microwave cavity; and
a mode stirrer operatively coupled to the waveguide and operable to distribute the electromagnetic energy received from the waveguide within the microwave cavity.

12. The separation system of claim 11, wherein the microwave generator, the power supply, and the waveguide are all disposed on a top side of the degassing tank, and the mode stirrer is arranged within the interior volume.

13. A method of separating oil and water from crude oil, comprising:
inputting the crude oil into a microwave cavity provided within an interior volume of a degassing tank; and
transmitting electromagnetic energy to the microwave cavity via a microwave generating system comprising a microwave generator operable to generate the electromagnetic energy in the form of microwaves,
wherein the electromagnetic energy interacts with the crude oil introduced into the interior volume and enhances separation of the oil from the water in the crude oil.

14. The method of claim 13. further comprising discharging the oil from the degassing tank via a first output and discharging the water from the degassing tank via a second output.

15. The method of claim 14. further comprising:
separating a gas from the crude oil; and
discharging the gas from the degassing tank via a third output.
